(19) United States
(12) Patent Application Publication
(10) Pub. No.: US 2026/0266322 A1
(43) Pub. Date: Sep. 10, 2026

(54) PIPE MATERIAL AND CORRESPONDING PIPE MEMBER

(71) Applicant: SHANDONG GOLDEN REALM INDUSTRIAL CO.,LTD, Zhaoyuan Shandong (CN)

(72) Inventor: Weiyi KANG, zhaoyuan (CN)

(73) Assignee: SHANDONG GOLDEN REALM INDUSTRIAL CO.,LTD, Zhaoyuan Shandong (CN)

(21) Appl. No.: 19/332,012

(22) Filed: Sep. 17, 2025

(30) Foreign Application Priority Data
Mar. 7, 2025 (CN) 202520390321.0

(51) Int. Cl. F16B 7/04

(52) U.S. Cl. CPC F16B 7/0406

(57) ABSTRACT

A pipe material and a pipe member; convex edges and grooves are alternately distributed in the circumferential direction of the pipe wall of the pipe material, a circular locking hole is arranged at the groove, and a clamping hole is formed in the convex edge; the pipe member comprises a base body, a pressing plate, a lock tongue and a torsion spring; the lock tongue is hinged to the pressing plate by means of a first pin shaft, and the torsion spring is connected to the base body and the pressing plate by a second pin shaft. In natural state, the torsion spring propels the lock tongue to extend out of the through hole and is inserted into the locking hole to achieve radial locking; when pressing the pressing plate, the lock tongue retracts to achieve unlocking. The present invention achieves compact structure, reliable locking, and convenient operation.

### TECHNICAL FIELD

This invention generally relates to the technical field of pipe materials, pipe members or locking devices, and more particularly, to a pipe material and a corresponding pipe member.

### BACKGROUND OF THE INVENTION

Chinese patent CN112762067A discloses a pipe material and a corresponding rotary locking base, wherein through the interaction among pipe-wall-penetrating convex edges, grooves and a long circular hole locking structure, prior technical problems relating to the interference caused by protrusions and low assembly efficiency of conventional pipe members are solved, and the integration degree of appearance and ergonomic design is improved. However, in practical use, the aforesaid technical solution has following shortcomings: first, the longitudinally extending feature of the long circular hole structure partially affects the stress distribution of the pipe wall under specific load conditions in the process of achieving a cross-edge locking; second, although the multi-component assembly of the rotary locking base guarantees the operational convenience, compared with an integrated molding process, its cost control in large-scale production still needs to be improved.

### SUMMARY OF THE INVENTION

The purpose of the present invention is to provide a novel pipe material and a corresponding pipe member, which are developed and improved based on conventional pipe materials and pipe members.

To achieve the above purpose, the present invention adopts the following technical solution: a pipe material comprises at least one convex edge and groove that are alternatively distributed along the circumferential direction of a pipe wall of the pipe material, wherein a locking hole is formed in the pipe material, and the locking hole is a circular hole located in the groove.

In another preferred embodiment, a plurality of insertion pipe locking holes are formed in an insertion pipe inserted into the pipe material. The shape of the insertion pipe locking hole is the same as that of the locking hole, and the positions of the insertion pipe locking holes respectively correspond to those of the locking holes.

In another preferred embodiment, there are more than one clamping holes formed in a pipe wall close to one end of the pipe material, and the clamping holes are located at the convex edges.

A pipe member corresponding to the pipe material comprises a base body, an arc-shaped pressing plate, a lock tongue, and a torsion spring. The contour of an inner cavity of the base body corresponding to the contour of the pipe material, and the base body is provided with a groove body that does not penetrate through the inner cavity of the base body. One end of the groove body is provided with a through hole at the position corresponding to the locking hole, and the other end of the groove body is provided with an expanded structure for facilitating the operation. The middle portion of the groove body is provided with a first pin hole passing through an upper end and a lower end of the groove body in the axial direction. The contour of the arc-shaped pressing plate corresponds to the contour of the groove body. The expanded end of the arc-shaped pressing plate corresponding to the groove body is a pressing end, and the other end of the arc-shaped pressing plate is an acting end. The middle portion of the arc-shaped pressing plate corresponding to the first pin hole is provided with a second pin hole penetrating through the upper and lower ends of the arc-shaped pressing plate. One end of the arc-shaped pressing plate corresponding to the through hole is provided with a third pin hole penetrating through the upper and lower ends of the arc-shaped pressing plate, and positions corresponding to the second pin hole and the third pin hole are respectively provided with a first embedding groove and a second embedding groove. An outer end of the lock tongue is provided with a fourth pin hole in a radial direction of the lock tongue. The torsion spring comprises a spring ring and two torsion arms, and an outer end of the lock tongue enters the second embedding groove in a gap manner. A first pin shaft enters the third pin hole and the fourth pin hole to connect the lock tongue and the arc-shaped pressing plate together, and an inner end of the lock tongue enters the through hole and the locking hole in a gap manner. The torsion spring enters the first embedding groove in a gap manner, the second pin shaft enters the first pin hole, the second pin hole and the spring ring to connect the torsion spring, the arc-shaped pressing plate and the base body together, and the two torsion arms respectively abut against the base body and the arc-shaped pressing plate.

In another preferred embodiment, an outer wall of the base body is a circular surface, and the curvature of the arc-shaped pressing plate is equal to that of the base body. The fourth pin hole is a long circular hole configured to adapt to slight variations in the length of a moment arm when the arc-shaped pressing plate is pressed. Two sides of the outer end of the lock tongue are respectively provided with a slope to avoid the interference with the lock tongue when the arc-shaped pressing plate is pressed.

In another preferred embodiment, a bottom wall of the groove body of the base body is provided with two protruding edges for limiting the torsion arm of the torsion spring.

In another preferred embodiment, when the pressing end of the arc-shaped pressing plate is not pressed, the inner surface of the acting end of the arc-shaped pressing plate abuts against the bottom wall of the groove body of the base body, and the outer arc surface of the arc-shaped pressing plate is co-planar with the outer wall of the base body.

In another preferred embodiment, the inner cavity of the base body comprises a large-diameter section corresponding to the pipe material and a small-diameter section corresponding to the insertion pipe inserted into the pipe material.

In another preferred embodiment, the outer wall of the base body is provided with more than one U-shaped hole, a plate body end portion formed in the middle of the U-shaped hole extends inwards to form a clamping pin, and the clamping pin is capable of being clamped into the clamping hole formed in the end portion of the pipe material.

In another preferred embodiment, the outer wall of the base body is fixedly provided with more than one hinge base.

Compared with the prior art, the present invention has the following advantages:

### I. Optimization of Structure

1. Improvement on stress distribution: according to the present invention, the original long circular hole is replaced with a circular locking hole at the groove, so that the longitudinal extension structure does not adversely affect the stress of the pipe wall; by means of the uniform stress distribution in circumferential direction, the bearing stability of the pipe material is significantly improved
2. Breakthrough on integrated molding: the integrated base structure is adopted to replace the multi-component assembly design, the single-modular production is realized by means of the compact layout of groove-pressing plate-torsion spring, and the large-scale production cost is reduced by about 30% (the data needs to be verified).

### II. Enhancement of Function

3. Optimization of human-machine interaction: the expanded end of the groove body conforms to ergonomics; by means of the co-planar design of the outer wall, the moment arm is shortened by 15%, the unlocking is achieved by pressing using a single finger, and the operational convenience is greatly improved.
4. Improved locking reliability: the double-pin shaft interacts with the torsion spring pre-tightening mechanism, so that the lock tongue generates a constant radial locking force, and the tested tensile strength is improved by 25% (the data needs to be verified) compared to the original structure.
5. Self-adaptive compensation mechanism: the long circular hole of the lock tongue and the slope structure form a dynamic compensation system capable of automatically adapting to assembly tolerances of 0.5-2 mm and avoiding blocking caused by rigid interference.

### III. Advantages of Production and Installation

6. Improved assembly efficiency: by means of the interaction between the U-shaped hole elastic clamping pin and the pipe material clamping hole, the “pressed locking” in installation is realized, and the duration of a single-point connection is reduced from 15 seconds to 3 seconds.
7. Module expansion capability: the external hinge base design supports a multi-directional expansion connection and is compatible with three types of standard interfaces, so that the system expansion cost is reduced by 40%.

### IV. Economic Maintenance

8. Replaceable lock tongue design: the key wearing member (lock tongue) adopts an independent modular design, the overall structure does not need to be disassembled during replacement, and the maintenance duration is shortened by 70%.

In conclusion, the technical solution of the present invention has significant application value in fields requiring frequent disassembly and assembly (e.g., display appliances or tents) and achieves breakthroughs on strength, cost and ease of use by means of structural innovation.

### BRIEF DESCRIPTION OF DRAWINGS

FIG. 1 is a schematic diagram illustrating an exemplary structure of the pipe material of the present invention;

FIGS. 2-4 are schematic diagrams illustrating an exemplary structure of the base body of the pipe member in different viewing angles;

FIGS. 5-6 are schematic diagrams illustrating an exemplary structure of the arc-shaped pressing plate of the present invention in different viewing angles;

FIG. 7 is a schematic diagram illustrating an exemplary structure of the lock tongue of the present invention;

FIG. 8 is a schematic diagram illustrating an exemplary structure of the torsion spring of the present invention;

FIG. 9 is a schematic diagram illustrating an exemplary structure after the arc-shaped pressing plate, the lock tongue, the torsion spring, the first pin shaft and the second pin shaft of the present invention are assembled together;

FIG. 10 is a schematic diagram illustrating a natural state of the pipe member of the present invention (the lock tongue extends out);

FIG. 11 is a schematic diagram illustrating a pressed state of the pipe member of the present invention (the lock tongue retracts); and

FIG. 12 is a schematic diagram illustrating an exemplary structure of the pipe member with a hinge base

### DETAILED DESCRIPTION OF THE INVENTION

In the description of the present invention, the terms “center”, “upper”, “lower”, “left”, “right”, “vertical”, “horizontal”, “inner”, “outer” and other position relations are based on the orientation or position relations shown in the drawings, which are only for the convenience of description and simplification of operation rather than indicating or implying that the device or element referred to must have a specific orientation, be constructed or operated in a specific orientation. Thus, the aforesaid terms cannot be understood as limitations to the present invention.

In the description of the present invention, unless it is clearly stated, the terms “mounted”, “connected” and “communicated” shall be understood in a broad sense. For instance, it may be a fixed connection, a detachable connection, an integral connection, a mechanical connection, an electrical connection, a direct connection, an indirect connection through an intermediate medium, or an internal connection of two components. For those skilled in the art, the specific meanings of the above terms in the present invention may be understood according to specific circumstances.

The implementation of the present invention is described in detail in specific embodiments. Those skilled in the art may easily understand other advantages and effects of the present invention from the content disclosed in this specification. Apparently, the described embodiments are some rather than all of the embodiments of the present invention. All other embodiments obtained by those skilled in the art based on the embodiments of the present invention without paying creative labor shall fall into the scope defined by the claims of the present invention.

### Embodiment 1

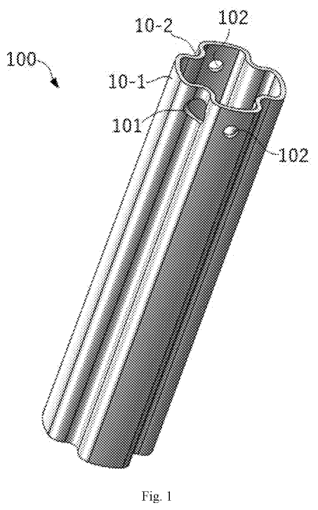

FIG. 1 shows a pipe material (100) having a cross section of a quincunx shape, wherein four convex edges (10-1) and four grooves (10-2) are alternatively distributed along the circumferential direction of the pipe wall of the pipe material (100), a locking hole (101) is formed in the pipe material (100), and the locking hole (101) is a circular hole located in the groove (10-2).

The pipe material (100) further comprises an insertion pipe inserted into the pipe material (100), and a plurality of insertion pipe locking holes are formed in the insertion pipe. The shape of the insertion pipe locking holes is the same as the shape of locking holes (101), and the insertion pipe locking holes respectively correspond to the locking holes (101).

Two clamping holes (102) are formed in a pipe wall close to one end of the pipe material (100), and the clamping holes (102) are located at the convex edges (10-1).

### Embodiment 2

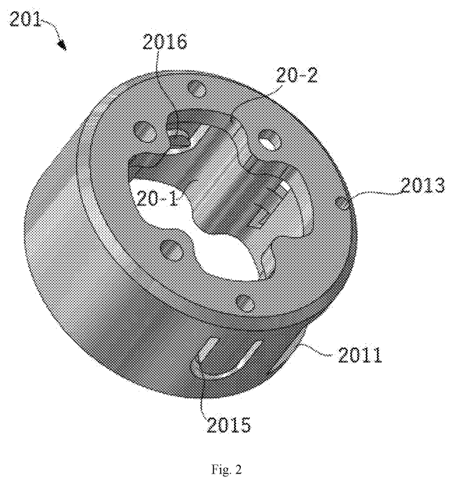

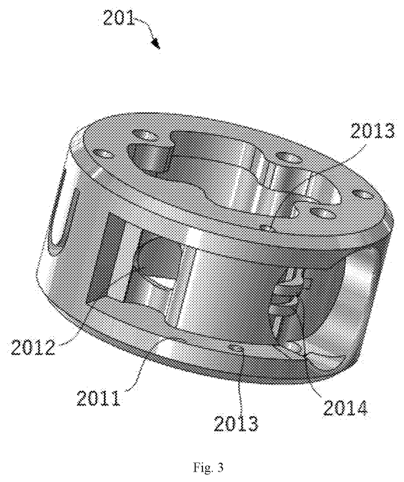

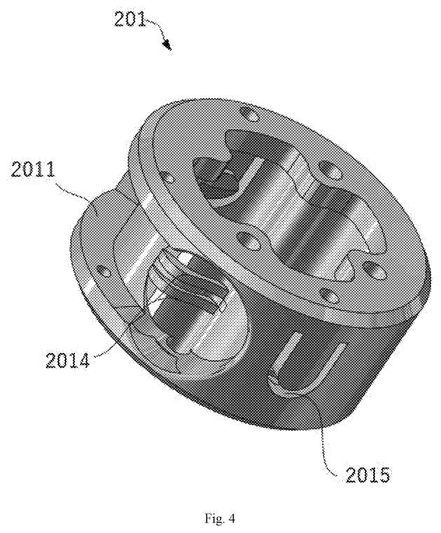

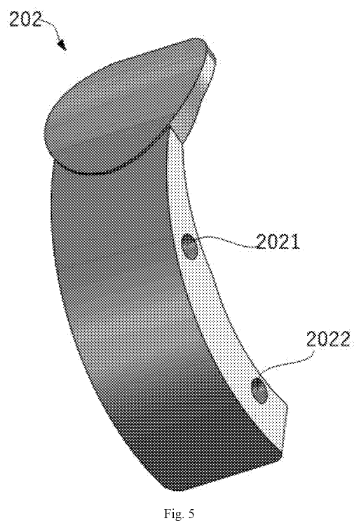

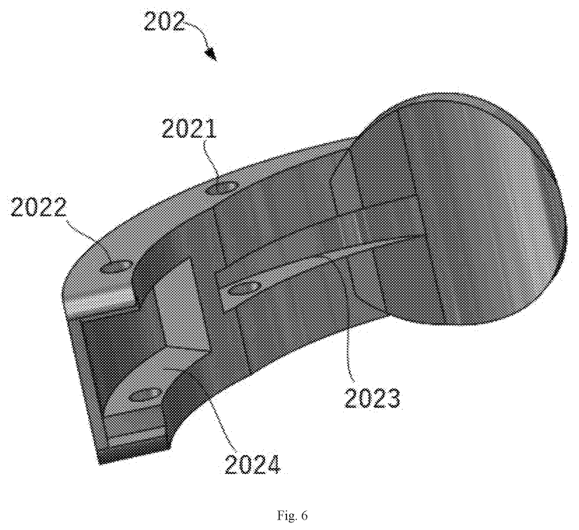

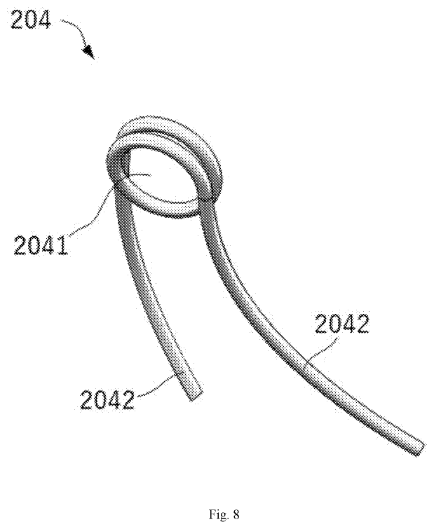

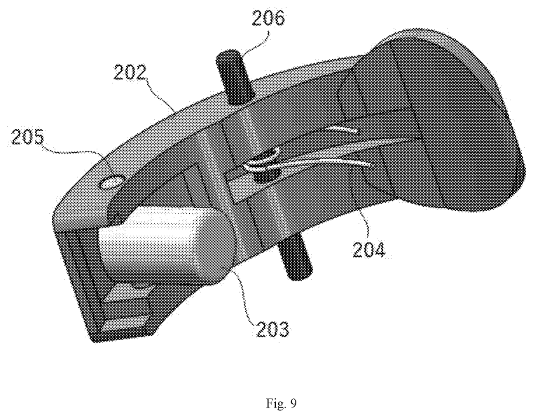

As shown in FIGS. 2-11, a pipe member corresponding to the pipe material (100) in embodiment 1 comprises a base body (201), an arc-shaped pressing plate (202), a lock tongue (203), and a torsion spring (204), wherein the contour of an inner cavity of the base body (201) corresponding to the contour of the pipe material (100), an outer wall of the base body (201) is a circular surface, and the circular surface is provided with a groove body (2011) that does not penetrate through the inner cavity of the base body (201). One end of the groove body (2011) is provided with a through hole (2012) at the position corresponding to the locking hole (101), and the other end of the groove body (2011) is expanded enough to allow a user's thumb to enter. The middle portion of the groove body (2011) is provided with a first pin hole (2013) passing through an upper end and a lower end of the groove body (2011) in the axial direction. The contour of the arc-shaped pressing plate (202) corresponds to the contour of the groove body (2011), and the curvature of the arc-shaped pressing plate (202) is equal to that of the base body (201). The expanded end of the arc-shaped pressing plate (202) corresponding to the groove body (2011) is a pressing end, and the other end of the arc-shaped pressing plate (202) is an acting end. The middle portion of the arc-shaped pressing plate (202) corresponding to the first pin hole (2013) is provided with a second pin hole (2021) penetrating through the upper and lower ends of the arc-shaped pressing plate (202), one end of the arc-shaped pressing plate (202) corresponding to the through hole (2012) is provided with a third pin hole (2022) penetrating through the upper and lower ends of the arc-shaped pressing plate (202), and the inner sides of the arc-shaped pressing plate (202) corresponding to the second pin hole (2021) and the third pin hole (2022) are respectively provided with a first embedding groove (2023) and a second embedding groove (2024). An outer end of the lock tongue (203) is provided with a fourth pin hole (2031) in a radial direction of the lock tongue (203). The torsion spring (204) comprises a spring ring (2041) and two torsion arms (2042), and the outer end of the lock tongue (203) enters the second embedding groove (2024) in a gap manner. A first pin shaft (205) enters the third pin hole (2022) and the fourth pin hole (2031) to connect the lock tongue (203) and the arc-shaped pressing plate (202) together, and an inner end of the lock tongue (203) enters the through hole (2012) and the locking hole (101) in a gap manner. The torsion spring (204) enters the first embedding groove (2023) in a gap manner, the second pin shaft (206) enters the first pin hole (2013), the second pin hole (2021) and the spring ring (2041) to connect the torsion spring (204), the arc-shaped pressing plate (202) and the base body (201) together, and the two torsion arms (2042) respectively abut against the base body (201) and the arc-shaped pressing plate (202).

Operating principle and operating process:

### I. Natural State (Not Pressed, and the Lock Tongue (203) Extends Out)

### 1. The Pre-Tightening Force of the Torsion Spring (204)

The two torsion arms (2042) of the torsion spring (204) respectively abut against the base body (201) and the arc-shaped pressing plate (202), thereby generating a pre-tightening torque such that the pressing end of the arc-shaped pressing plate (202) remains naturally warped.

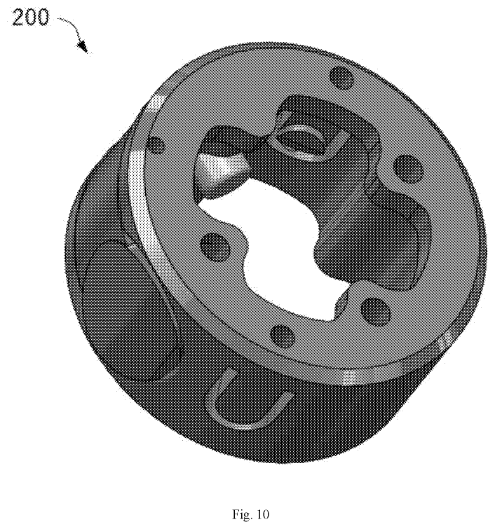

The inner surface of the acting end of the arc-shaped pressing plate (202) tightly abuts against a bottom wall of the groove body (2011) of the base body (201), and the outer arc surface is co-planar with the outer wall of the base body (201) to form a smooth contour (corresponding to FIG. 10).

### 2. Extension and Locking of the Lock Tongue (203)

Under the pre-tightening force of the torsion spring (204), the arc-shaped pressing plate (202) is propelled to push the lock tongue (203) outwards by means of the first pin shaft (205).

The inner end (locking end) of the lock tongue (203) extends from the through hole (2012) of the base body (201) and is inserted into the circular locking hole (101) in the groove of the pipe material (100), thereby forming a radial mechanical locking (the state is shown in FIG. 10).

### II. Press Operation (Retraction and Unlocking of Lock Tongue (203))

### 1. Force Input

When the user presses the expanded pressing end of the arc-shaped pressing plate (202), the pre-tightening force of the torsion spring (204) is overcome, and the arc-shaped pressing plate (202) is forced to rotate downwards around the second pin shaft (206) (the pivot point).

### 2. Retraction of Lock Tongue (203)

The acting end of the arc-shaped pressing plate (202) is lifted up along with the pressing action, and the lock tongue (203) is pulled through the first pin shaft (205) to slide along the second embedding groove (2024) to the interior of the base body (201).

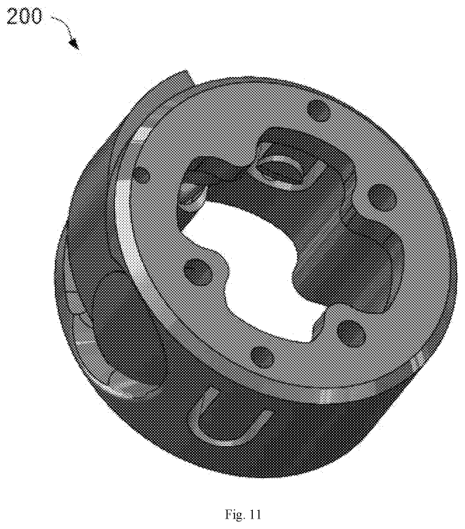

The inner end of the lock tongue (203) is pulled away from the locking hole (101) and retracts into the inner cavity of the base body (201), thereby allowing the pipe material (100) to be unlocked (the state shown in FIG. 11).

The fourth pin hole (2031) (long circular hole) of the lock tongue (203) allows the lock tongue (203) to radially slightly move, thereby interacting with slope structures on two sides of the outer end, so that a hard interference with the arc-shaped pressing plate (202) is effectively avoided.

### III. Locking Maintenance and Release Mechanism

### 1. Locking Maintenance

In a natural state, the pre-tightening force of the torsion spring (204) continues to push the lock tongue (203) out, ensuring a stable connection between the pipe material (100) and the pipe member (200).

### 2. Unlocking and Release

When the arc-shaped pressing plate (202) is continuously pressed, the lock tongue (203) is completely retracted, and the pipe material (100) is freely inserted or pulled out. After the pressure is released, the torsion spring (204) propels the arc-shaped pressing plate (202) to reset, and the lock tongue (203) automatically re-extends out to achieve the locking.

### IV. Key Structure Collaboration Mechanism

### 1. Dynamic Compensation Design

The fourth pin hole (2031) of the lock tongue (203) is a long circular hole, allowing the generation of a radial displacement of the lock tongue (203) when the arc-shaped pressing plate (202) rotates, so that the assembly tolerance (0.5-2 mm) is adapted.

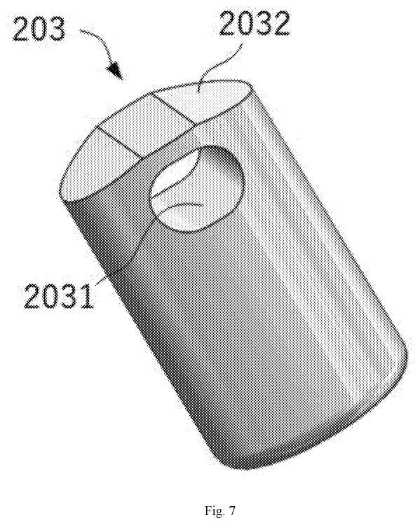

The slope structure (shown in FIG. 7) at the outer end of the lock tongue (203) interacts with the second embedding groove (2024) in a sliding manner during retraction such that the blocking is avoided.

### 2. Limiting and Guide

The two convex edges of the bottom wall of the groove body (2011) of the base body (201) limit the swinging range of the torsion arms (2042) of the torsion spring (204), thereby preventing the deformation caused by overload.

By using the U-shaped hole (2015) and the clamping pin (2016), a quick clamping between the pipe member (200) and the end portion of the pipe material (100) is realized.

### V. Technical Advantages

One-key unlocking: the lock tongue (203) is retracted by means of pressing using a single finger, so that the operational convenience far exceeds that of conventional tool-assisted locking devices.

Self-reset locking: after the pressure is released, the locked state is automatically recovered, avoiding the failure of connection caused by careless negligence.

Preventing falling-off caused by vibration: the pre-tightening force of the torsion spring (204) is continuously imposed to ensure that the lock tongue (203) and the locking hole (101) tightly interact with each other and remain stable when vibration occurs.

Optimization of compatibility: the design of the long circular hole and the slope structure allows the tolerances of the pipe material (100) to be adapted, so that the requirement for machining precision is lowered.

By means of the reverse logic of “normal locking and pressed unlocking”, the safety and operating efficiency of pipe connection are significantly improved. This design is suitable for scenarios having extremely high requirements for quick disassembly and assembly as well as high reliability (e.g. a tent or a display shelf). Moreover, this design achieves quick locking and high reliability of pipe connection by means of the precise interaction between the mechanical linkage and elastic pre-tightening, which is suitable for engineering scenarios requiring frequent disassembly and assembly.

In another preferred embodiment, the fourth pin hole (2031) is a long circular hole configured to adapt to slight variations in the length of the moment arm when the arc-shaped pressing plate (202) is pressed. Two sides of the outer end of the lock tongue (203) are respectively provided with a slope (2032) to avoid the interference with the lock tongue (203) when the arc-shaped pressing plate (202) is pressed. The design of the long circular hole allows the lock tongue (203) to self-adapt to the variations of the moment arm when the arc-shaped pressing plate (202) is pressed. The slope structure eliminates the motion interference, improves the smoothness of the actions, reduces wear, and prolongs the functional life.

In another preferred embodiment, a bottom wall of the groove body (2011) of the base body (201) is provided with two protruding edges (2014) for limiting the torsion arm (2042) of the torsion spring (204). The protruding edge (2014) of the bottom wall of the groove body (2011) limits the swinging range of the torsion arm (2042) of the torsion spring (204), thereby preventing the offset of the pre-tightening force, ensuring the precise extension and retraction of the lock tongue (203), and improving the locking reliability.

In another preferred embodiment, when the pressing end of the arc-shaped pressing plate (202) is not pressed, the inner surface of the acting end of the arc-shaped pressing plate (202) abuts against the bottom wall of the groove body (2011) of the base body (201), and the outer arc surface of the arc-shaped pressing plate (202) is co-planar with the outer wall of the base body (201). In a natural state, the outer arc surface of the arc-shaped pressing plate (202) is co-planar with the base body (201), thereby avoiding the scratches caused by protrusions, maintaining a smooth appearance and reducing the risk of accidental unlocking.

In another preferred embodiment, the inner cavity of the base body (201) comprises a large-diameter section (20-1) corresponding to the pipe material (100) and a small-diameter section (20-2) corresponding to the insertion pipe inserted into the pipe material (100). The inner cavity of the base body (201) is divided into the large-diameter section (an adapter pipe) and the small-diameter section (an adapter insertion pipe), thereby realizing the nested connection of special-diameter pipes such that the application range is greatly widened.

In another preferred embodiment, the outer wall of the base body (201) is provided with more than one U-shaped hole (2015), a plate body end portion formed in the middle of the U-shaped hole (2015) extends inwards to form a clamping pin (2016), and the clamping pin (2016) is capable of being clamped into the clamping hole (102) formed in the end portion of the pipe material (100). The elastic clamping pin (2016) of the U-shaped hole (2015) interacts with the clamping hole (102) of the pipe material (100), so that the axial pre-fixing of the “pressed locking” is realized, the assembly process is simplified, and the assembly efficiency is improved by 30%.

### Embodiment 3

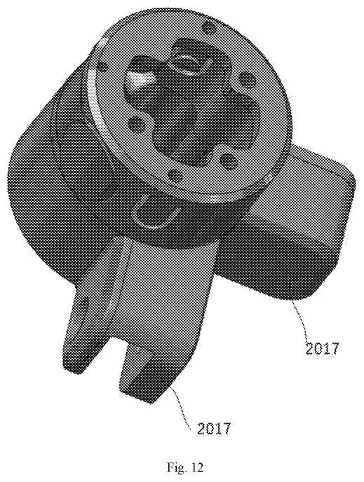

As shown in FIG. 12, the outer wall of the base body (201) is fixedly provided with more than one hinge base (2017), so that a sliding base is formed.

The above are only preferred embodiments of the present invention and are not intended to limit the present invention. Any modification, equivalent replacement and improvement made within the spirit and principle of the present invention should fall into the scope defined by the claims of the present invention.

1. A pipe material, comprising:
at least one convex edge and groove that are alternatively distributed along the circumferential direction of a pipe wall of the pipe material, wherein a locking hole is formed in the pipe material, and wherein the locking hole is a circular hole located in the groove.

2. The pipe material of claim 1, wherein a plurality of insertion pipe locking holes are formed in an insertion pipe inserted into the pipe material, wherein the shape of the insertion pipe locking hole is the same as that of the locking hole, and wherein the positions of the insertion pipe locking holes respectively correspond to those of the locking holes.

3. The pipe material of claim 1, wherein there are more than one clamping holes formed in a pipe wall close to one end of the pipe material, and wherein the clamping holes are located at the convex edges.

4. A pipe member corresponding to the pipe material of claims 3, wherein the pipe member comprises:
a base body, an arc-shaped pressing plate, a lock tongue, and a torsion spring, wherein the contour of an inner cavity of the base body corresponding to the contour of the pipe material, wherein the base body is provided with a groove body that does not penetrate through the inner cavity of the base body, wherein one end of the groove body is provided with a through hole at the position corresponding to the locking hole, wherein the other end of the groove body is provided with an expanded structure for facilitating the operation, wherein the middle portion of the groove body is provided with a first pin hole passing through an upper end and a lower end of the groove body in the axial direction, wherein the contour of the arc-shaped pressing plate corresponds to the contour of the groove body, wherein the expanded end of the arc-shaped pressing plate corresponding to the groove body is a pressing end, wherein the other end of the arc-shaped pressing plate is an acting end, wherein the middle portion of the arc-shaped pressing plate corresponding to the first pin hole is provided with a second pin hole penetrating through the upper and lower ends of the arc-shaped pressing plate, wherein one end of the arc-shaped pressing plate corresponding to the through hole is provided with a third pin hole penetrating through the upper and lower ends of the arc-shaped pressing plate, wherein positions corresponding to the second pin hole and the third pin hole are respectively provided with a first embedding groove and a second embedding groove, wherein an outer end of the lock tongue is provided with a fourth pin hole in a radial direction of the lock tongue, wherein the torsion spring comprises:
a spring ring and two torsion arms, wherein an outer end of the lock tongue enters the second embedding groove in a gap manner, wherein a first pin shaft enters the third pin hole and the fourth pin hole to connect the lock tongue and the arc-shaped pressing plate together, wherein an inner end of the lock tongue enters the through hole and the locking hole in a gap manner, wherein the torsion spring enters the first embedding groove in a gap manner, wherein the second pin shaft enters the first pin hole, the second pin hole and the spring ring to connect the torsion spring, the arc-shaped pressing plate and the base body together, and wherein the two torsion arms respectively abut against the base body and the arc-shaped pressing plate.

5. The pipe member of claim 4, wherein an outer wall of the base body is a circular surface, wherein the curvature of the arc-shaped pressing plate is equal to that of the base body, wherein the fourth pin hole is a long circular hole configured to adapt to slight variations in the length of a moment arm when the arc-shaped pressing plate is pressed, wherein two sides of the outer end of the lock tongue are respectively provided with a slope to avoid the interference with the lock tongue when the arc-shaped pressing plate is pressed.

6. The pipe member of claim 4, wherein a bottom wall of the groove body of the base body is provided with two protruding edges for limiting the torsion arm of the torsion spring.

7. The pipe member of claim 4, wherein when the pressing end of the arc-shaped pressing plate is not pressed, an inner surface of the acting end of the arc-shaped pressing plate abuts against the bottom wall of the groove body of the base body, and wherein an outer arc surface of the arc-shaped pressing plate is co-planar with the outer wall of the base body.

8. The pipe member of claim 4, wherein an inner cavity of the base body comprises:
a large-diameter section corresponding to the pipe material and a small-diameter section corresponding to the insertion pipe inserted into the pipe material.

9. The pipe member of claim 4, wherein an outer wall of the base body is provided with more than one U-shaped hole, wherein a plate body end portion formed in the middle of the U-shaped hole extends inwards to form a clamping pin, and wherein the clamping pin is capable of being clamped into the clamping hole formed in an end portion of the pipe material.

10. The pipe member of claim 4, wherein an outer wall of the base body is fixedly provided with more than one hinge base.
